(19) United States
(12) Patent Application Publication
(10) Pub. No.: US 2021/0048000 A1
(43) Pub. Date: Feb. 18, 2021

(54) GENERATOR FOR A WIND TURBINE, WIND TURBINE COMPRISING SAME, METHOD FOR LOCKING A GENERATOR, AND USE OF A LOCKING DEVICE

(71) Applicant: Wobben Properties GmbH, Aurich (DE)

(72) Inventor: Frank SAATHOFF, Aurich (DE)

(21) Appl. No.: 16/976,634

(22) PCT Filed: Feb. 28, 2019
(86) PCT No.: PCT/EP2019/054994

§ 371 Date: Aug. 28, 2020

(30) Foreign Application Priority Data
Feb. 28, 2018 (DE) 10 2018 104 627.8

(51) Int. Cl. F03D 9/25; F03D 80/50; F03D 17/00

(52) U.S. Cl. CPC F03D 9/25; F03D 80/50; F03D 17/00; F05B 2220/705; F05B 2260/902; F05B 2260/83; F05B 2220/706; F05B 2260/31

(57) ABSTRACT

A generator, in particular a generator of a wind turbine, comprising a rotatably mounted generator rotor, a generator stator which corresponds to the generator rotor and which has a support structure for fixing in the wind turbine, and at least one arresting device which is configured to be coupled in between the generator rotor and the generator stator in such a way that there is a force flow between the generator rotor and the generator stator and which is adapted in the coupled state to arrest the generator rotor in a predetermined position relative to the generator stator. The arresting device has a damping element which is variable in shape such as to deform as a result of the force flow between the generator rotor and the generator stator.

### BACKGROUND

### Technical Field

The present invention concerns a generator, in particular a generator of a wind turbine. The invention further concerns a wind turbine comprising same. Furthermore the invention concerns a method of arresting a rotor of a generator and the use of an arresting device.

### Description of the Related Art

Wind turbines are generally known. They are used to receive wind energy by means of rotor blades and convert it into electrical energy by means of the generator. In that case the generator includes a generator stator which has a support structure for fixing in the wind turbine, and a generator rotor operatively connected to the rotor of the wind turbine. The generator rotor is rotated relative to the generator stator. Electric power is generated by the relative rotation of the generator rotor relative to the generator stator so that the kinetic energy of the wind is converted into electrical energy. The magnetic interactions which occur can result in the production of audible narrow-band sounds, thereby giving rise to additional acoustic pollution for the environment.

In order to combat that unwanted noise generation the wind turbine is being made the subject of investigations in terms of vibration technology. The vibration characteristic of generators is detected for example by modal analysis operations, with the aim of wide-reaching evaluation of the probable service life of the generator and potential environmental pollution.

When carrying out modal analyses operations, in particular experimental modal analysis, a defined external excitation is applied. The vibration behavior of the individual components of an assembly is detected by sensors and analyzed.

In regard to modal analysis on wind turbines it is necessary for safety reasons to arrest the generator rotor relative to the generator stator. Arresting devices are known from the state of the art, which can be brought into engagement with the generator rotor in positively locking relationship and which prevent it from rotation about a horizontal axis. The aim of the arresting devices known from the state of the art is in particular to provide for a secure arresting action. The reason for that is in particular to safeguard people working on the wind turbines by means of suitable safety precautions. Therefore, rotor arresting devices known in the state of the art predominantly involve combinations of bolts and corresponding openings.

The arresting devices known from the state of the art can provide a secure rigid arresting action for the rotor, but that rigid connection of generator rotor and generator stator results in superimposition of the vibrations of the two components, whereby the result of modal analysis is falsified.

### BRIEF SUMMARY

Provided is a generator with an arresting device which arrests the generator rotor relative to the generator stator in a predetermined position and at the same time minimizes the transmission of vibrations of the generator rotor to the generator stator. At any event provided is an alternative generator.

Provided is a generator of a wind turbine, comprising a rotatably mounted generator rotor, a generator stator which corresponds to the generator rotor and which has a support structure for fixing in the wind turbine, and at least one arresting device which can be coupled between the generator rotor and the generator stator in such a way that there is a force flow between the generator rotor and the generator stator and which is adapted in the coupled state to arrest the generator rotor in a predetermined position relative to the generator stator. Provided is a wind turbine comprising same. Furthermore provided is a method of arresting a rotor of a generator and the use of an arresting device.

Provided is a generator having arresting device having a damping element which is adapted to be variable in shape in such a way that it is deformed as a result of the force flow between the generator rotor and the generator stator.

The generator can in that respect be used both in wind turbines which are gearless and also in wind turbines which have a gear transmission.

The damping element of the arresting device, which is designed to be variable in shape in such a way that it is deformed as a result of the force flow between the generator rotor and the generator stator therefore damps the vibrations of the generator rotor and the generator stator and prevents the generation of a resonance vibration. Coupling of the arresting device in between the generator rotor and the generator stator can be effected both in positively locking relationship and also force-locking relationship. Rotation of the generator rotor relative to the generator stator is prevented by the force flow occurring between the generator rotor and the generator stator.

In a preferred embodiment of the generator, the damping element is designed to be variable in shape in such a way that the generator rotor is movable in the radial direction relative to the generator stator. Proposed an arresting action which very substantially does not impede the vibration behavior of the generator rotor and the generator stator in the radial direction and thus only slightly influences the measurement values of a modal analysis, like for example the natural frequency.

An advantageous development provides that the damping element is designed to be variable in shape in such a way that the generator rotor is movable in the axial direction relative to the generator stator. Therefore there is proposed an arresting action very which substantially does not impede the vibration behavior of the generator rotor and the generator stator in the axial direction and thus only slightly influences the measurement values of a modal analysis like for example the natural frequency.

An advantageous development provides that the damping element is designed to be variable in shape in such a way that the mobility of the generator rotor relative to the generator stator is restricted in the peripheral direction compared to the mobility in the radial or axial direction respectively. Therefore there is proposed an arresting device which proposes secure arresting of the generator rotor relative to the generator stator but at least restrictedly damps the force flow between the generator rotor and the generator stator in the peripheral direction.

The damping element experiences a tensile or compression force by a movement of the generator rotor and the generator stator in the peripheral direction. A relative movement of the generator stator and the generator rotor in the axial or radial direction respectively gives rise to shearing forces which act on the damping element. As the shearing modulus G is lower in known manner than the elasticity modulus E consequently the required shearing stress which has to be applied to move a defined point by the distance Δl is also less than the tensile or compression stress which would have to be applied for displacement by Δl.

In a preferred embodiment, the arresting device has a holding arm having a stator end and a rotor end, wherein provided at the stator end is a receiving means for the damping element which is adapted to receive the damping element and, on which receiving means is arranged the damping element and which is adapted to receive the damping element and which can be brought into contact with the support structure. There is thus proposed a holding arm which makes a cost-efficient connection which can be handled well between the damping element and the clamping unit.

In a particularly preferred development provided at the rotor end of the holding arm is a clamping unit which has at least one opening through which connecting means, in particular screws can be passed, and which is adapted to connect the arresting device to the generator rotor. There is thus proposed a clamping unit which provides for easy rapid coupling and uncoupling of the arresting device to and from the generator rotor.

In a further particularly preferred development the support structure has a plurality of segments, wherein each of the segments has a first side and a second side arranged in opposite relationship in the peripheral direction, and a first arresting device can be brought into contact with the first side of the support structure and at least one further arresting device can be brought into contact with the at least one second side of the support structure, wherein the operative direction of the first arresting device extends substantially in opposite relationship to the operative direction of the second arresting device. The disclosure makes use of the realization that the generator rotor can be arrested by arresting by two oppositely directed arresting devices, when there is a greatly varying loading on the rotor of the wind turbine as a result of rotating winds. In addition the force flow of the rotor, acting on the support structure, is applied to the support structure more uniformly and thus results in a lower level of stressing of the segments of the support structure and the wind turbine components connected thereto.

In a preferred development, the damping element can be filled with a pressurized fluid, in particular compressed air. The disclosure makes use of the realization that the degree of damping can be controlled in the tangential, radial and axial directions by filling with a pressurized fluid. In addition the stiffness of the damping element is controllable by the filling in such a way that the shearing or flexing behavior of the damping element and thus the arresting action on the generator rotor relative to the generator stator in the tangential, radial and axial directions is controllable.

If compressed air is used as the filling medium for the damper elements that gives the further advantage that in a leakage situation no contamination occurs in the generator, as could be the case for example when using oil as the filling medium.

The term operative direction of the arresting device is used here to mean that the operative direction extends, preferably in the peripheral direction of the generator, substantially perpendicularly to the contact surface between the respective support structure and the respective damping element.

A further preferred development, provides a braking device adapted to reduce the relative speed of the generator rotor or at any event to temporarily hold the generator rotor after reaching a standstill, in which case the braking device has a brake unit and a brake disk operatively connected to the generator rotor.

The disclosure makes use of the realization that the braking device facilitates positioning of the generator rotor relative to the generator stator whereby arresting, in particular positively locking arresting, of the generator rotor relative to the generator stator is facilitated.

In a further preferred development, the arresting device can be coupled to the brake disk. In regard to the coupling action the disclosure makes use of the realization that the brake disk is in most cases better accessible than the generator rotor itself, and the operatively connected generator rotor is also arrested in a predetermined position relative to the generator stator by virtue of arresting the brake disk.

In a particularly preferred development, the brake disk has recesses and the clamping unit is adapted to be coupled to the brake disk by means of a clamping connection, in particular a clamping connection in the region of the recesses.

According to a further aspect, provided is attained by a wind turbine having a nacelle, a machine support arranged in the nacelle and a rotor rotatably mounted to the nacelle, characterized by a generator in accordance with one of the above-described variants, operatively connected to the rotor. In regard to the advantages achieved and preferred embodiments attention is directed in this respect to the foregoing configurations of the generator. By virtue of the wind turbine being provided with such a generator it also affords the corresponding advantages.

Preferably the wind turbine further has a device for rigid arresting, which is adapted in the coupled state to rigidly arrest the generator rotor relative to the generator stator, in particular for carrying out maintenance and assembly operations, in a predetermined position, and also to be released again after conclusion of the works. In that case the device is preferably in the form of a holding brake or a positively locking arresting device.

According to a further aspect provided is a method of arresting a rotor of a generator, in particular a generator according to one of the above-described preferred embodiments, including the steps: holding the generator rotor in a predetermined position relative to the generator stator, coupling the arresting device in between the generator rotor and the generator stator in such a way that a force flow occurs between the generator rotor and the generator stator, wherein the arresting device has a damping element which is designed to be variable in shape in such a way that it is deformed as a result of the force flow between the generator rotor and the generator stator, and uncoupling of the damping arresting device from the generator rotor and/or generator stator. The arresting device is preferably an arresting device according to one of the above-described preferred embodiments. The method makes use of the same advantages and preferred embodiments as the generator. In regard to the advantages achieved and the preferred embodiments therefore attention is directed to the foregoing description of the generator.

In a particularly preferred development it includes the implementation of a modal analysis for determining the dynamic behavior. The modal analysis is preferably effected after coupling of the arresting device in between the generator rotor and the generator stator and before uncoupling of the arresting device from the generator rotor and/or generator stator. There is therefore proposed a method of vibrational investigation of wind turbines.

Preferably the damping element can be filled with a pressurized fluid, in particular compressed air. An advantageous development of the method provides that in the coupling step the damping element is firstly fitted between the generator and the stator and is then filled in such a way that it comes into contact with the support structure. Filling of the damping element in the mounted state and/or of the arresting device markedly facilitates assembly.

According to a last aspect, provided is the use of a damping arresting device in the initiation and implementation of a modal analysis for determining the dynamic behavior of a generator, in particular a generator according to at least one of the above-described embodiments, wherein the arresting device has a damping element which is designed to be variable in shape in such a way that it is deformed as a consequence of the force flow between the generator rotor and the generator stator.

In regard to the advantages achieved and preferred embodiments attention is directed in that respect to the foregoing description of the generator, in particular the damping arresting device of the generator. The use of such an arresting device in initiating and implementing modal analysis for determining the dynamic behavior on a generator affords the corresponding advantages.

The magnetic interactions which occur and which can lead to the generation of audible narrow-band sounds and possibly an adverse effect on service life are caused in particular by the relative movement of the generator rotor and the generator stator in the radial direction. In terms of investigating the vibration characteristic it is therefore of particular importance to detect without interference the vibrations of rotor and stator in the radial direction.

The generator can be in particular a synchronous generator, an asynchronous generator or a double-feed asynchronous generator. An example of a synchronous generator is a multi-pole synchronous ring generator of a wind turbine, in which respect it is also possible to use other generators including other synchronous generators. Such a multi-pole synchronous ring generator of a wind turbine has a plurality of stator teeth, in particular at least 48 stator teeth, frequently even markedly more like for example 96 stator teeth or still more stator teeth. The magnetically active region of the synchronous generator, namely both the generator rotor and also the generator stator, is arranged in an annular region around the axis of rotation of the synchronous generator.

The generator preferably has a magnetically active region, namely both of the rotor and also the stator, which is arranged in an annular region around the axis of rotation of the synchronous generator. Depending on the respective structure of the wind turbine there can be a support structure in the inner region, which however in some structures can be of an axially displaced design.

The generator is preferably separately excited.

In a preferred embodiment the generator is a slowly rotating generator. That is used to mean a generator having a speed of rotation of 100 revolutions per minute or fewer, preferably 50 revolutions per minute or fewer, particularly preferably in a range of 5 to 35 revolutions per minute.

### BRIEF DESCRIPTION OF THE SEVERAL VIEWS OF THE DRAWINGS

The invention is described in greater detail hereinafter by means of preferred embodiments with reference to the accompanying Figures in which:

FIG. 1 is a diagrammatic perspective view of a wind turbine,

FIG. 2 is a diagrammatic view of a rotor of a wind turbine as shown in FIG. 1,

FIG. 3 shows a part of the view of the rotor and an arresting device as shown in FIG. 2,

FIG. 4 shows a diagrammatic view of the arresting device of FIG. 2,

FIG. 5a shows a part of the arresting device of FIG. 4 without relative movement,

FIG. 5b shows a part of the arresting device of FIG. 4 with relative movement in the radial direction,

FIG. 5c shows a part of the arresting device of FIG. 4 with relative movement in the axial direction, and

FIG. 5d shows a part of the arresting device of FIG. 4 with relative movement in the peripheral direction.

### DETAILED DESCRIPTION

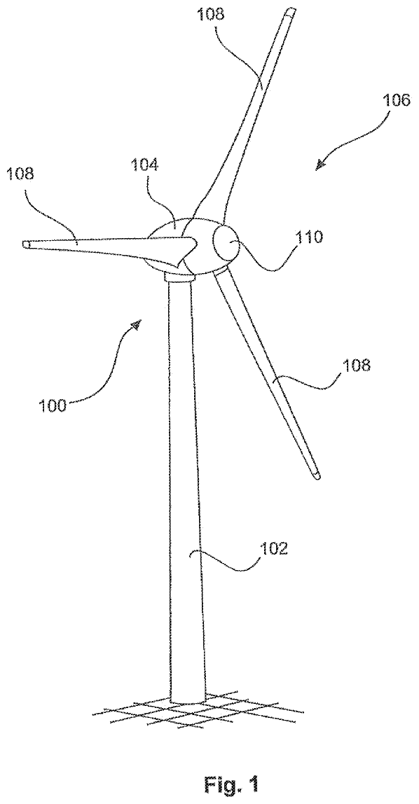

FIG. 1 shows a wind turbine 100 having a tower 102 and a nacelle 104. Arranged on the nacelle 104 is a rotor 106 having three rotor blades 108 and a spinner 110. The rotor blades 108 are mounted with their rotor blade roots to a rotor hub. In operation the rotor 106 is caused to rotate by the wind and thereby drives a generator (not shown) in the nacelle 104.

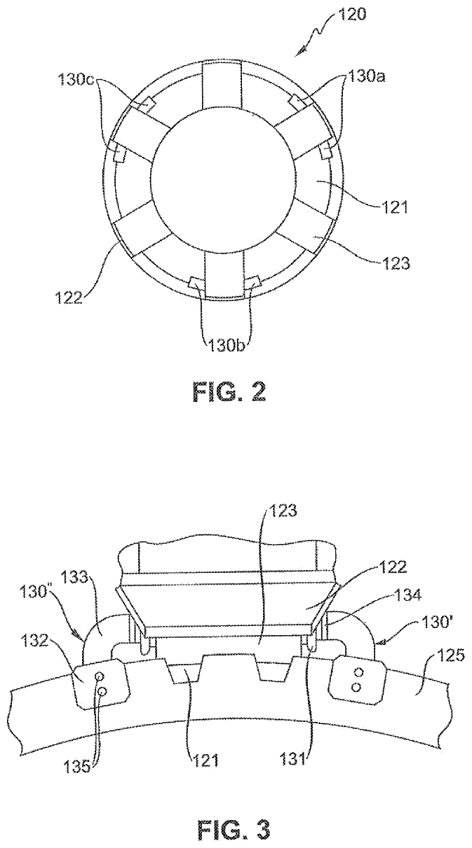

FIG. 2 shows a generator 120, in particular a generator for the wind turbine, having a rotatably mounted generator rotor 121, a generator stator 122 which corresponds to the generator rotor 121 and has a support structure 123 for fixing in the wind turbine 100. The stator support structure 123 further has a plurality of segments 123a, 123b, 123c and at least a first side 123′ and a second side 123″.

Each segment of the stator support structure 123a, 123b, 123c has at least a first side 123a, 123b, 123c and a second side 123″a, 123″b, 123″c. In addition arranged in the generator 120 are at least three arresting devices 130a, 130b, 130c which are coupled in between the generator rotor 121 and the generator stator 122 in such a way that there is a force flow between the generator rotor 121 and the generator stator 122.

The arresting devices 130a, 130b, 130c arrest the generator rotor 121 relative to the generator stator 122 in a predetermined position. In that case a respective first arresting device 130′, 130′a, 130′b, 130′a is in contact with a first side of the stator structure 123′a, 123′b, 123′c and a second arresting device 130″a, 130″b, 130″c is in contact with a second side of the stator support structure 123″a, 123″b, 123″c.

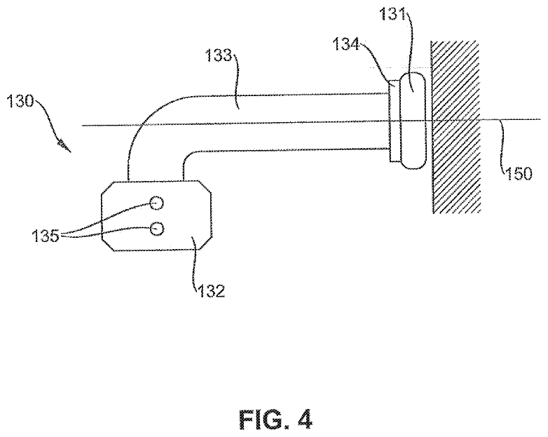

FIG. 3 shows a portion of the generator 120 of FIG. 1. In the illustrated preferred embodiment the rotatably mounted rotor 121 is operatively connected to a brake disk 125 which is so designed that it has a plurality of openings along its periphery.

The generator stator 122 is connected to a support structure 123. The stator support structure 123 is adapted to connect the generator stator 122 to the wind turbine 100. The stator support structure 123 further has a plurality of segments 123a, 123b, 123c and at least a first side 123′ and a second side 123″.

The arresting device 130′, 130″ is coupled to the brake disk 125 of a braking device of the generator rotor 121. In addition the arresting device 130′ is in contact with a first side of the support structure 123′ and the arresting device 130″ is in contact with a second side of the support structure 123″ of the generator stator 122.

The arresting device 130′, 130″ also has a holding arm 133 having a stator end with a receiving means 134 for the damping element 131 and a rotor end.

A damping element 131 is arranged at the stator end of the arresting device 130 at the receiving means 134. Provided at the rotor end is a clamping unit 132 having one or more openings 135 through which connecting means, for example screw connections, can be passed to make the clamping connection.

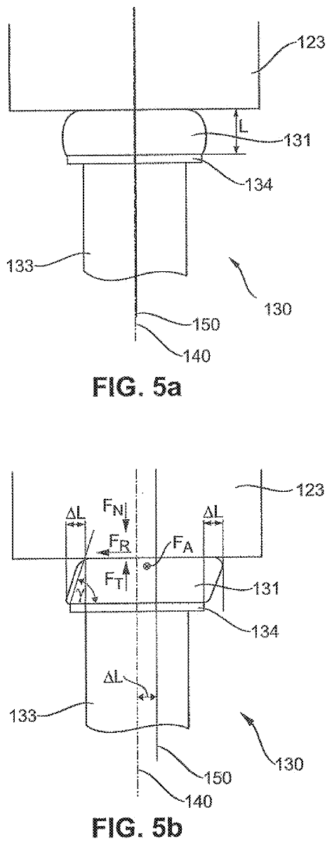

FIG. 4 shows the arresting device 130. The arresting device 130 includes a holding arm 133 having a stator end at which is arranged a receiving means 134 for a damping element and a damping element 131. The holding arm 133 further has a rotor end at which there is a clamping unit 132. The clamping unit 132 has at least one opening 135, through which connecting means, in particular screws, can be passed to make a clamping connection.

The contact surface between the support structure 123 and the damping element 131 extends substantially perpendicularly to an axis 150. The operative direction of the damping element 131, starting from the periphery of the rotor 121, extends substantially parallel to the axis 150.

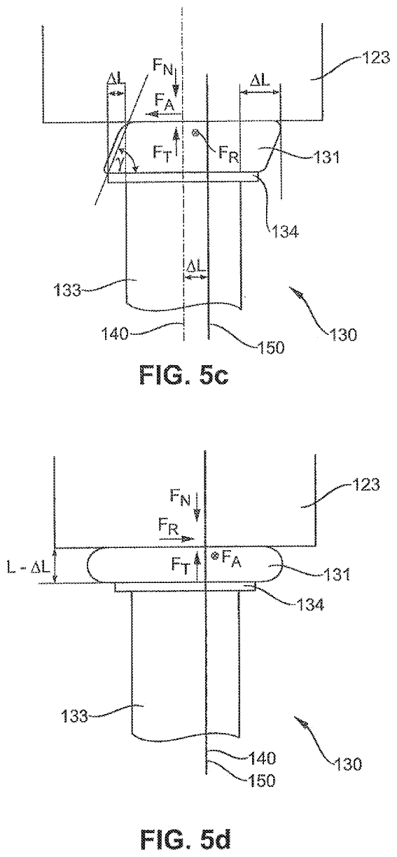

FIG. 5a shows a portion of the arresting device 130 in the rest state. The arresting device 130 includes an axis of symmetry 140, a holding arm 133 having a stator end at which are arranged a receiving means 134 for a damping element and a damping element 131. The damping element 131 is in contact with the support structure 123 of the stator 122. The contact surface between the support structure 123 and the damping element 131 extends substantially perpendicularly to the axis 150.

FIG. 5a further shows an axis 150 which extends substantially perpendicularly to the radial of the generator 120 and which substantially coincides with the axis of symmetry 140 of the arresting device 130.

The arresting device 130 experiences a force F_{T1} in the peripheral direction through the rotor 121, that is transmitted to the damping element 131. The damping element is of a height L.

FIG. 5b shows a portion of the arresting device 130, corresponding to FIG. 5a, which under the action of a force FR experiences a relative movement in the radial direction. The arresting device 130 further experiences a force F_{T1} in the peripheral direction through the rotor 121, that is transmitted to the damping element 131. In that arrangement the damping element is of a height L. The damping element 131 which is variable in shape substantially experiences a shearing effect by ΔL as a result of the force F_{R}.

In addition FIG. 5b shows an axis 150 which, with the relative movement in the radial direction, is at a spacing ΔL relative to the axis of symmetry 140 of the arresting device 130.

FIG. 5c shows a portion of the arresting device 130 corresponding to FIG. 5a, which under the action of a force F_{A} experiences a relative movement in the axial direction. The arresting device 130 further experiences a force F_{T1} in the peripheral direction through the rotor 121, which is transmitted to the damping element 131. In that arrangement the damping element is of a height L. In that case the damping element 131 which is variable in shape experiences substantially a shearing action by ΔL as a consequence of the force F_{R}.

In addition FIG. 5c shows an axis 150 which, with the relative movement in the axial direction, is at a spacing ΔL relative to the axis of symmetry 140 of the arresting device 130.

FIG. 5d shows a portion of the arresting device 130 corresponding to FIG. 5a, which under the effect of a force F_{T2} (F_{T2}>>F_{T1}) through the rotor experiences a relative movement in the peripheral direction. The force F_{T2} is transmitted to the damping element 131 so that the height of the damping element which is variable in shape is upset by ΔL.

FIG. 5d further shows an axis 150 which substantially coincides with the axis of symmetry 140 of the arresting device 130.

On the simplified assumption that forces act exclusively in the peripheral direction on the damping element 131 then for extension or upsetting ε by ΔL the tensile or compression stress σ to be applied is derived as follows:

σ=E·ε=E·ΔL,

with E as the modulus of elasticity.

On the simplified assumption that forces act exclusively in the radial and axial direction respectively on the damping element 131 then for shearing by the angle γ the shearing stress τ to be applied is derived as follows:

$$τ = G \cdot tan γ = G \cdot \frac{Δ L}{L} ,$$

with G as the shearing modulus.

Accordingly as L>>ΔL and G<E this provides that consequently the force to be applied for a relative movement AL in the radial or axial direction is a multiple less than a force in the axial or radial direction respectively.

1. A generator, comprising
a rotatably mounted generator rotor,
a generator stator corresponding to the generator rotor and having a support structure configured for attachment inside a wind turbine, and
at least one arresting device configured to be coupled in between the generator rotor and the generator stator and configured to establish a flux of force between the generator rotor and the generator stator, wherein the at least one arresting device is configured to arrest the generator rotor in a predetermined position relative to the generator stator when in the coupled state,
wherein the arresting device comprises a damping element which is variable in shape such as to deform as a result of the flux of force between the generator rotor and the generator stator.

2. The generator as set forth in claim 1 wherein the damping element is configured to be variable in shape such that the generator rotor is movable in a radial direction relative to the generator stator.

3. The generator as set forth in claim 1 wherein the damping element is designed to be variable in shape in such a way that the generator rotor is movable in a axial direction relative to the generator stator.

4. The generator as set forth in claim 1 wherein the damping element is designed to be variable in shape in such a way that the generator rotor is only movable to a lesser extent in a peripheral direction relative to the generator stator compared to a mobility in a radial or an axial direction, respectively.

5. The generator as set forth in claim 1 wherein the arresting device comprises a holding arm having a stator end and a rotor end, wherein a receiving means for the damping element is provided at the stator end, wherein the damping element which is configured to be brought into contact with the support structure and is arranged at the stator end.

6. The generator as set forth in claim 5 wherein provided at the rotor end of the holding arm is a clamping unit having at least one opening configured to receive a connector and to connect the arresting device to the generator rotor.

7. The generator as set forth in claim 1 wherein the support structure has a plurality of segments, wherein each of the plurality of segments has a first side, a second side, a first arresting device configured to be brought into contact with the first side of the support structure, and a second arresting device configured to be brought into contact with the second side of the support structure, wherein an operative direction of the first arresting device extends substantially in opposite relationship to an operative direction of the second arresting device.

8. The generator as set forth in claim 1 wherein the damping element is configured to be filled with a pressurized fluid.

9. The generator as set forth in claim 1 comprising a braking device configured to reduce a relative speed of the generator rotor, wherein the braking device has a mechanical brake unit and a brake disk operatively coupled to the generator rotor.

10. The generator as set forth in claim 9 wherein the arresting device is configured to be coupled to the brake disk.

11. The generator as set forth in claim 9 wherein the brake disk comprises a plurality of recesses, and wherein the clamping unit is configured to be coupled to the brake disk by a clamping connection.

12. A wind turbine comprising:
a nacelle,
a machine support arranged in the nacelle,
a rotor rotatably mounted to the nacelle, and
a generator as set forth in claim 1 operatively coupled to the rotor.

13. A method of comprising:
arresting a generator rotor of a generator, the arresting comprising:
holding the generator rotor in a predetermined position relative to a generator stator of the generator, and
coupling a damping arresting device in between the generator rotor and the generator stator to establish a flux of force between the generator rotor and the generator stator, and
uncoupling the damping arresting device from at least one of the generator rotor or the generator stator.

14. The method as set forth in claim 13 wherein before the arresting, the method comprises:
braking of the generator rotor, and
locking the generator rotor relative to the generator stator in a predetermined position.

15. The method as set forth in claim 13 further comprising performing a modal analysis to determine a dynamic behavior of the generator.

16. A method comprising:
using an arresting device for arresting a generator rotor of a generator, of a wind turbine, and
performing a modal analysis to determine the dynamic behavior of the generator, wherein the arresting device has a damping element that is variable in shape such as to deform as a result of force flow between the generator rotor and a generator stator of the generator.

17. The generator as set forth in claim 8 wherein the pressurized fluid is compressed air.

18. The generator as set forth in claim 11 wherein the clamping connection is in the region of the plurality of recesses.

19. The generator as set forth in claim 15 wherein the modal analysis is performed after the generator rotor has been arrested and before the damping arresting device is uncoupled.
